(19) United States
(12) Patent Application Publication
(10) Pub. No.: US 2007/0162864 A1
(43) Pub. Date: Jul. 12, 2007

(54) User-directed repartitioning of content on tab-based interfaces

(75) Inventors: Eric L. Masselle, Raleigh, NC (US); Anuphinh Phimmasorn, Durham, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corp., Armonk, NY (US)

(21) Appl. No.: 11/328,691

(22) Filed: Jan. 10, 2006

(51) Int. Cl. G06F 9/00

(52) U.S. Cl. 715/765; 715/777; 715/811; 715/841

(57) ABSTRACT

A method, system, and computer program product for providing user-directed repartitioning of content on tab-based interfaces that includes providing a tab-based interface, having a plurality of tabs, wherein each tab has an associated content view and allowing for the manipulating of one, or more, tab, so as to repartition the associated content view with the concomitant tab manipulation.

### BACKGROUND OF THE INVENTION

1. Field of the Invention

The present invention relates generally to tab-based user interfaces. More specifically, the present invention offers a customizing improvement to tab-based user interfaces by providing a method, system, and computer program product for user-directed repartitioning of content of tab-based interfaces, that includes inter alia tab merging.

2. Background Art

Currently, there exist various software products that offer tab-based interfaces. Such products include Mozilla Firefox, FluxBox, and the like. Tab-based interfaces include having separate physical indicia (e.g., “tabs”) to associate with separate Web pages and typically have a single browser window showing these tabs so as to allow switching between the tabs and their associated Web pages. That is the tabs, provided with a tab-based interface, are not unlike the small, typically colored, plastic tabs attached to various sheets of paper in a stack of papers. The tabs allow, in this software environment, a user to identify and move between the various Web pages (i.e., “sheets of paper”) fairly readily.

While convenient, current tab-based interfaces do not offer the user much in the way of content organization and content control. Most interfaces are unwieldy and inflexible to the user. That is, the tab-based interfaces generally are not customizable as to accommodate personal usage and needs.

For example, a user is continually forced to switch between tabs so as to compare content between the two, or more, “tabbed” views. This is both time consuming and confusing.

Often, a user mentally “links” together two, or more, views wherein, because of common content, use, interest, etc. between the views, the user is constantly switching (e.g., “tabbing”) between these two (or more) particular views. This commonality of more than one tabbed content may exist only temporarily, during the instant working session, or project; or, this commonality may exist for the user, in essence, permanently (i.e., beyond the single working session). In either event, there is currently no readily available way for a user to get these multiple content views in a common interface.

In view of the foregoing, there exists a need for a method, system, and computer program product for an improvement in tab-based user interfaces that provides for user-directed repartitioning of content of tab-based interfaces. The user will have a richer experience using tab-based interfaces that allow for inter alia merging of tab content and, additionally, that allow for these merged tabs to persist across sessions.

### SUMMARY OF THE INVENTION

In general, the present invention provides a method, system, and computer program product for user-directed repartitioning of content of tab-based interfaces. In particular, the present invention includes a unique improvement on tab-based interfaces that allows for the repartitioning of the various associated content views via the concomitant manipulation of one, or more, of the tabs in the interface.

A first aspect of the present invention provides a method for user-directed repartitioning of content of tab-based interfaces comprising: providing a tab-based interface, wherein the interface includes a plurality of tabs, wherein each tab has an associated content view; and manipulating a tab to repartition the associated content view.

A second aspect of the present invention provides a system for providing user-directed repartitioning of content of tab-based interfaces, comprising: a system for providing a tab-based interface, wherein the interface includes a plurality of tabs, wherein each tab has an associated content view; and a system for manipulating a tab to repartition the associated content view.

A third aspect of the present invention provides a program product stored on a recordable medium for providing user-directed repartitioning of content of tab-based interfaces, which when executed comprises: program code for providing a tab-based interface, wherein the interface includes a plurality of tabs, wherein each tab has an associated content view; and program code for manipulating a tab to repartition the associated content view.

A fourth aspect of the present invention provides a system for deploying an application for providing user-directed repartitioning of content of tab-based interfaces, comprising: providing a computer infrastructure being operable to: provide a tab-based interface, wherein the interface includes a plurality of tabs, wherein each tab has an associated content view; and manipulate a tab to repartition the associated content view.

A fifth aspect of the present invention provides computer software embodied in a propagated signal for providing user-directed repartitioning of content of tab-based interfaces, the computer software comprising instructions to cause a computer system to perform the following functions: providing a tab-based interface, wherein the interface includes a plurality of tabs, wherein each tab has an associated content view; and manipulating a tab to repartition the associated content view.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative computer screen having a tab-based user interface of the related art.

FIG. 2 depicts a close up of the tab portions of a tab-based user interface, in accordance with the present invention.

FIG. 3A depicts the view of the tab-based interface in FIG. 2 with two tabs merged, in accordance with the present invention.

FIG. 3B depicts the view of the tab-based interface in FIG. 3A with action dropdown menu open, in accordance with the present invention.

FIG. 4 depicts the view of the tab-based interface in FIG. 2 with a three tabs merged, in accordance with the present invention.

FIG. 5A depicts the view in FIG. 3A with the two merged tabs undergoing splitting, in accordance with the present invention.

FIG. 5B depicts the view in FIG. 5A with the two merged tabs having been split, in accordance with the present invention.

FIG. 6 depicts a view of a tab-based user interface including screen view(s), in accordance with the present invention.

FIG. 7A depicts a schematic view of a first embodiment of a tab-based user interface, in accordance with the present invention.

FIG. 7B depicts a schematic view of a second embodiment of a tab-based user interface, in accordance with the present invention.

FIG. 7C depicts a schematic view of a third embodiment of a tab-based user interface, in accordance with the present invention.

FIG. 7D depicts a schematic view of a fourth embodiment of a tab-based user interface, in accordance with the present invention.

FIG. 8 depicts a flow diagram illustrating the process flow of a portion of a method in accordance with the present invention.

FIG. 9 depicts a computer system for implementing the method of the present invention.

The drawings are merely schematic representations, not intended to portray specific parameters of the invention, and are not necessarily to scale. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for providing user-directed repartitioning of content of tab-based interfaces.

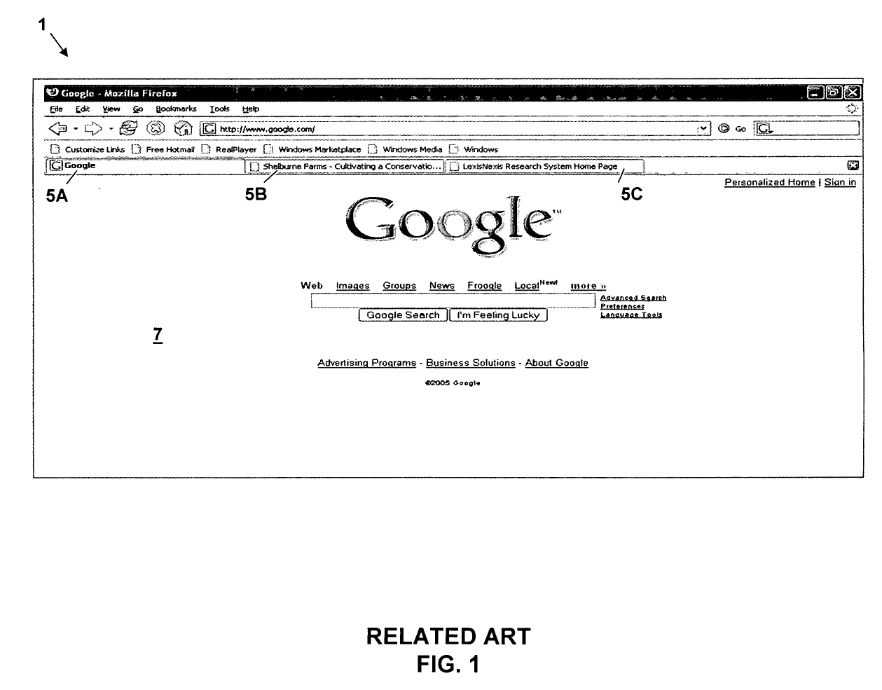

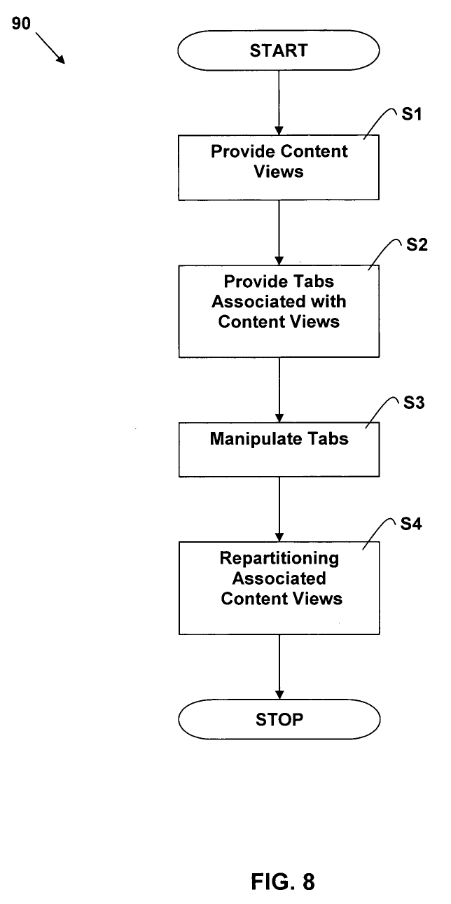

Referring to the drawings, FIG. 1 depicts a typical screen display 1 of a tab-based interface. The screen display 1 includes at least one tab 5 that has a content view 7 associated with it. Typically, there is a plurality of tabs 5 (e.g., 5A, 5B, 5C) so that a user 104 (FIG. 8) can switch (i.e., “tab”) between the various tabs 5 and thereby switch the screen display 1 between the various content views 7 for each particular tab 5.

In the embodiment shown in FIG. 1, there are three tabs 5A (i.e., “Google”), 5B (i.e., “Shelburne Farms”), and 5C (i.e., LexisNexis Research). Shown in the screen display 1 is the content view 7 for Google (i.e., tab 5A). Thus, if the user, opts to see the content view 7 of either “Shelburne Farms” or “LexisNexis”, he or she must select the associated tab 5B, 5C so as to switch the screen display 1 to the particular, associated content view 7.

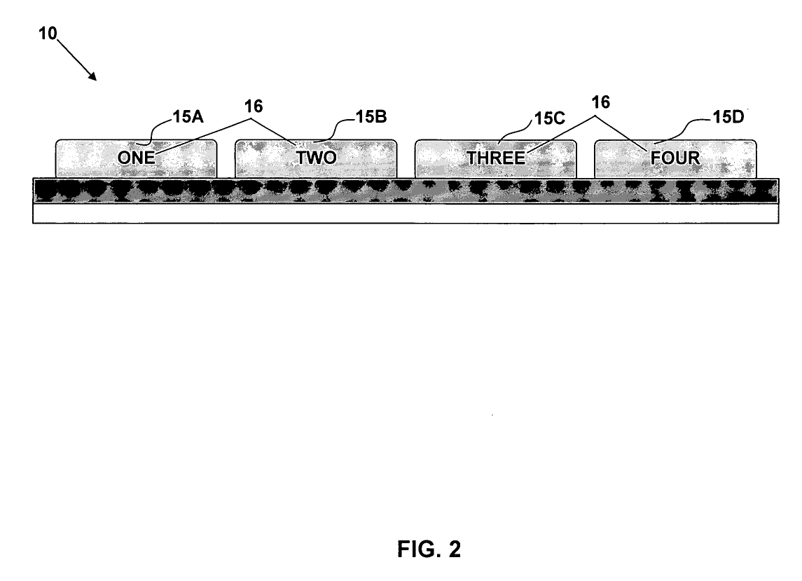

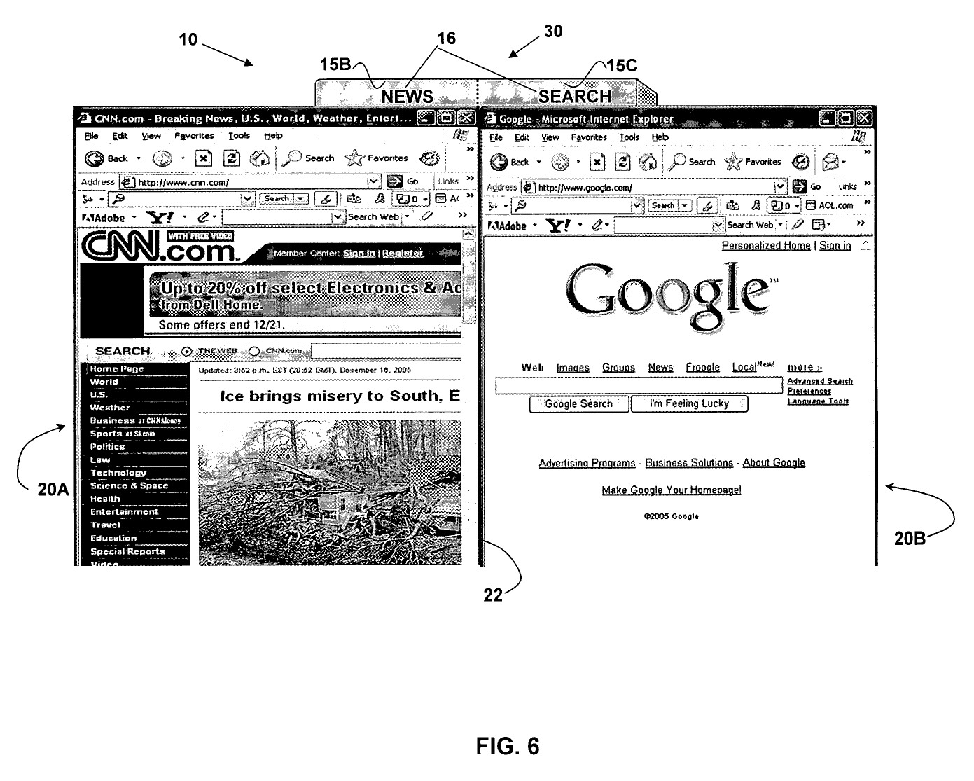

FIGS. 2 through 8 show various embodiments of the present invention which provides for an improvement of tab-based interfaces. The tab-based interface of the present invention may comprise a tabbed browser, a tabbed portal interface, or similarly functioning interface. A screen display 10 of the present invention similarly has one, or more, tabs 15 associated with it. In FIG. 2, four tabs (i.e., 15A, 15B, 15C, 15D) are shown in the screen display 10, wherein each tab 15 has an associated content view 20 (see e.g., FIG. 6). Each tab 15 has associated indicia 16 to communicate the content view 20 that the particular tab 15 represents. Although the various tabs 15 in FIG. 2 merely have indicia 16 of “One”, “Two”, “Three”, and “Four”, respectively, clearly the indicia 16 may be any visual indicator that assists in providing information as to the particular content view 20 associated therein. For example, indicia 16 may be “New”, “Sports”, “Hobbies”, and the like.

Tabs 15 are defined to include any visual indicator that represents a portion of an associated content view 20 and the like. For example, although the tabs 15 shown herein are rectangular-shaped tabs, clearly other shapes, sizes, configurations, locations, etc. may be employed to provide the same functionality of the tabs described and shown herein.

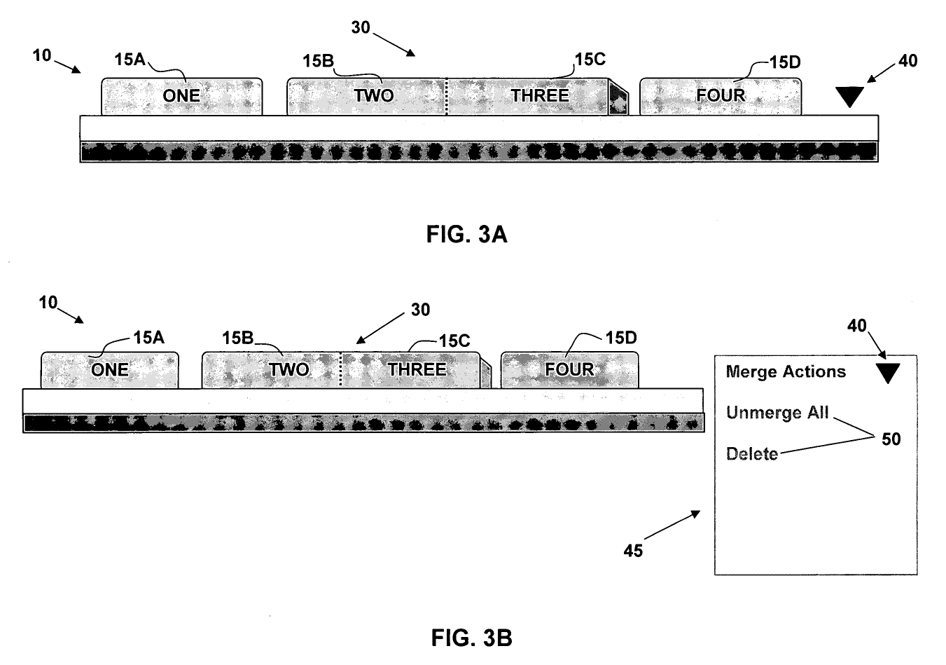

The present invention allows for the user to direct the repartitioning of the various content views 20 by manipulating a tab 15, or plurality of tabs 15. For example, FIG. 3A shows the same view of tabs 15 from FIG. 2, wherein the user has merged two tabs (i.e., 15B, 15C) into a single tabbed construct 30. In the embodiment shown, although tab “Two” 15B and tab “Three” 15C have been merged, the indicia have remained intact. Further, upon the merging of the tabs 15, a dropdown indicator 40 has appeared.

Upon selecting the dropdown indicator 40 (FIG. 3B), a user views a content box 45, menu, or the like. The content box 45 allows the user to select what actions they wish to take on one, or more than one, tabs 15 and their associated content views 20 (FIG. 6). For example, the selections 50 in the content box 45 include “Unmerge All” and “Delete”. A selection of the “Unmerge All” choice would result in the system unmerging, or unlinking, any merged tabs 30. A selection of the “Delete” choice would result in the system deleting any selected tabs 15 and/or merged tabs 30.

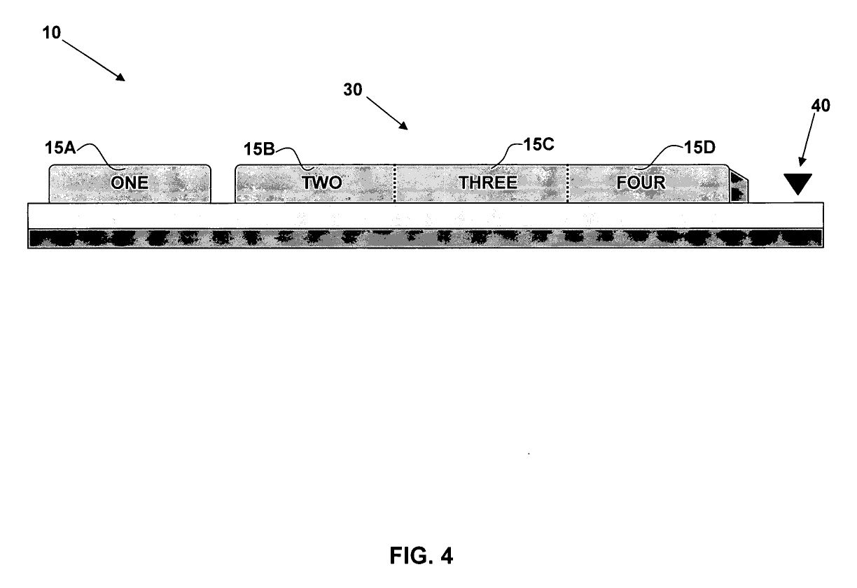

Clearly, under the present invention any merging of tabs 15 need not be limited to only the merging of two tabs 15. As FIG. 4 shows, three tabs (e.g., 15B, 15C, 15D) have been successfully manipulated into a single merged tab 30.

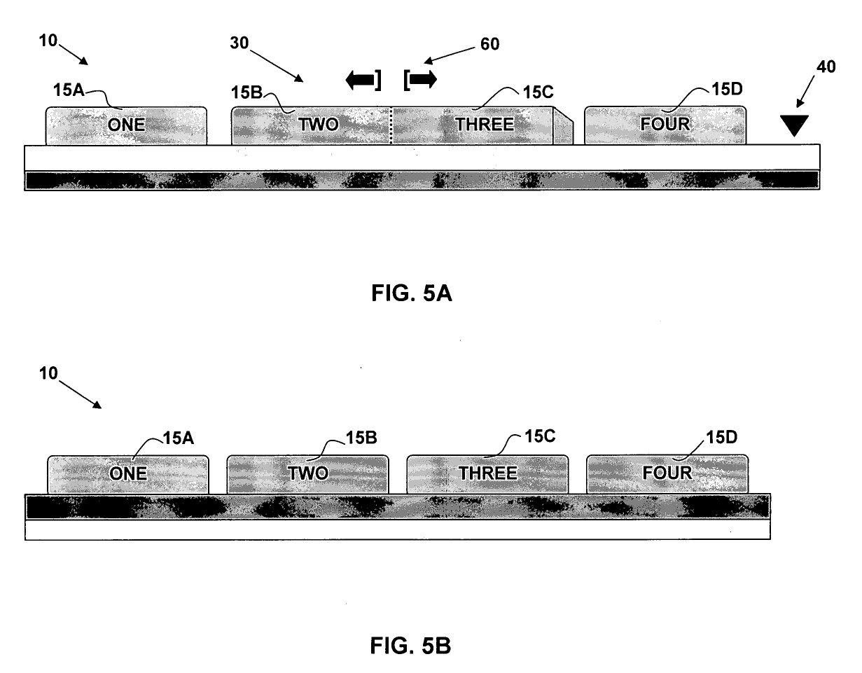

Similarly, as FIGS. 5A and 5B indicate, just as tabs 15 and their associated content views 20 (FIG. 6) may manipulated, by merging, so too can each, or all, merged tabs 30 become unmerged, in part, or in total. For example, as FIG. 5A shows, two tabs 15A, 15B have been previously merged into merged tab 30. For example, if the user places an icon (not shown) over the dotted line between the tabs 15A, 15B, a split icon 16 may appear. The user may manipulate the icon 16 (e.g., moving the arrows, etc.) so as to separate the tabs 15A, 15B so that they become split, or unmerged. Alternatively, for example, simply clicking “ok” (not shown) or accepting an action, the merged tab 30 gets split, or unmerged, resulting in the view 10 as shown in FIG. 5B.

Thus, by manipulating one, or more, tabs 15 the user is causing the repartitioning, in some fashion, the associated content views 20 associate with the tabs 15. Manipulating may entail merging two, or more, tabs 15 along with the associate content views 20. Upon merging two, or more, tabs 15, the actual tabs 15 may be consumed (e.g., disappear from view), or the two, or more, tabs 15 may remain intact in the merged tab 30. Manipulating may entail unmerging, or splitting, the merged tab 30. Similarly, indicia 16 may, or may not, survive the manipulation of the tab(s) 15. So too may indicia 16 be edited, changed, deleted, etc. Additionally, the partitioned view created by the manipulation of the tab(s) 15 may be saved by the user.

FIG. 6 shows an exemplary screen view 10 wherein two tabs 15B, 15C have been merged into a merged tab 30, in a manner as described above. Each tab 15B,15C has an associated content view 20. For example, tab 15B has an associated content view 20A (e.g., www.CNN.com), while tab 15C has an associated content view 20B (e.g., www.google.com). Each tab 15 may have an indicia 16. For example, tab 15B has an indicia 16 “News”, while tab 15C has an indicia 16 “Search”. Clearly, indicia 16 may be user-defined (i.e., customizable) or machine created. Thus, upon the manipulating of the tabs 15, the content views 20A, 20B are repartitioned so that they concurrently appear within the screen view 10 when tab 30 is selected. In the embodiment shown, the content views 20A, 20B are partitioned side-by-side, or in a horizontal merging embodiment. Contrastingly, the content views 20 may be partitioned in a top-to-bottom, or vertical merging scenario (not shown).

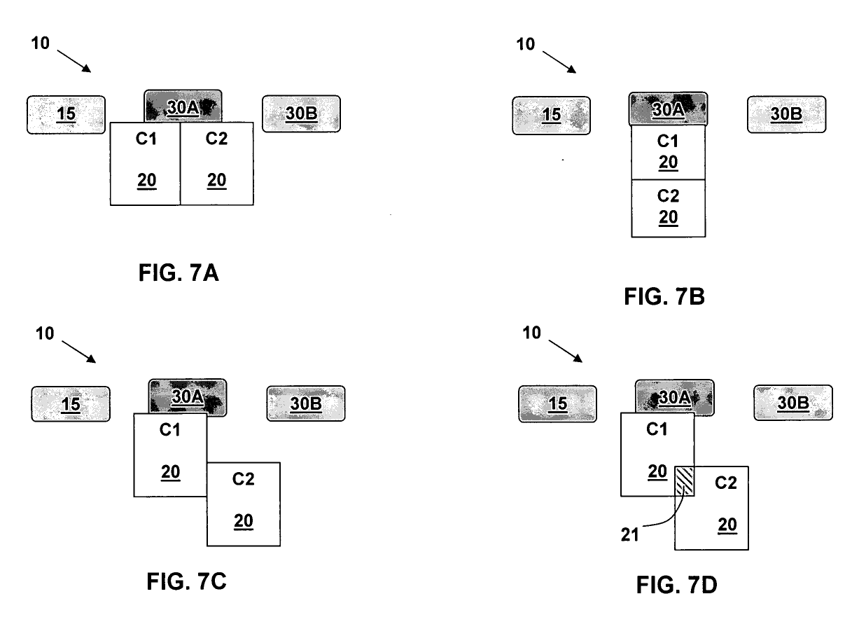

FIGS. 7A through 7D show schematic views of various embodiments of exemplary screen views 10. Each screen view 10 includes a manipulated tab 30A that has been selected by the user 104 for viewing as the instant exemplary screen view 10. While the selected manipulated (e.g., merged) tab 30A in each embodiment will show concurrently the associated content views 20. In all four examples (i.e., FIG. 7A, 7B, 7C, 7D), the associated content views 20 include “C1” and “C2” for schematic purposes. The associated content view 20 may be all, or a portion of the associated content from a web page, and the like.

Other tab selections that are instantly not being selected by the user 104 are shown as tab 15 and merged tab 30B for illustration purposes only. Clearly, although only a single tab 15 and single, unselected merged tab 30B are shown, there may exist a plurality of either, or both tabs 15 and merged tabs 30. Alternatively, there may be no additional selections available besides the selected merged tab 30A.

Thus, for example, FIG. 7A depicts a selected merged tab 30A wherein the associate content views “C1” and “C2” 20 are shown in a side-by-side (i.e., horizontally merged) configuration. Alternatively, FIG. 7B depicts a selected merged tab 30A wherein the associate content views “C1” and “C2” 20 are shown in a top-and-bottom (i.e., vertically merged) configuration. FIG. 7C still depicts a selected merged tab 30A wherein the associate content views “C1” and “C2” 20 are shown in a diagonal (e.g., “staggered” or “tiled”) configuration. Finally, FIG. 7D depicts a selected merged tab 30A wherein the associate content views “C1” and “C2” 20 are shown in a diagonal but overlapped configuration. Note that a portion of either “C1” 20 and/or “C2” 20 is overlapped hidden from view to the user 104, as denoted by 21. Clearly, other configurations, shapes, and designs for showing all or a portion of an associated content view 20 is available with the present invention.

A method, denoted by 90, in accordance with the present invention, is shown in FIG. 8. One embodiment of the method 90 starts with step S1, wherein various content views are provided. Step S2 follows wherein one, or more, tabs are associated with the various content views. Next, step S3 provides for the manipulation of one, or more, of the tabs, having the associated content views. The method 90 is completed upon step S4, wherein upon the manipulation of the tab(s), the associated content views are repartitioned accordingly.

The present invention ultimately provides the advantage of user-directed repartitioning of content of tab-based interfaces.

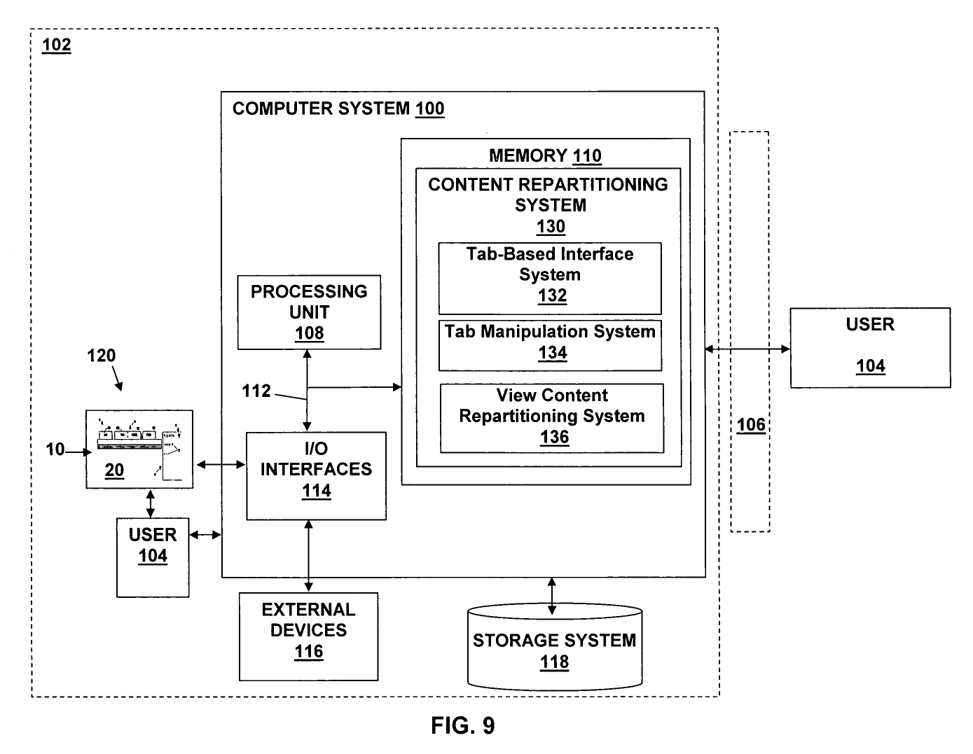

A computer system 100 for providing user-directed repartitioning of content of tab-based interfaces in accordance with an embodiment of the present invention is depicted in FIG. 9. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for user-directed repartitioning of content of tab-based interfaces, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as a Content Repartitioning System 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 9 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a Content Repartitioning System 130 for providing a user-directed repartitioning of content of tab-based interfaces in accordance with embodiment(s) of the present invention. The Content Repartitioning System 130 generally includes a Tab-Based Interface System 132 for providing a tab-based interface, as described above. The Content Repartitioning System 130 generally also includes a Tab Manipulation System 134 for providing a system of tabs associated with the various content views that can be manipulated and a View Content Repartitioning System 136 for repartitioning the various content views in consort with the tab manipulations, as described above.

The present invention can be offered as a business method on a subscription or fee basis. For example, one or more components of the present invention can be created, maintained, supported, and/or deployed by a service provider that offers the functions described herein for customers. That is, a service provider can be used to provide a service for providing user-directed repartitioning of content of tab-based interfaces, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

We claim:

1. A method for providing user-directed repartitioning of content of tab-based interfaces, comprising:
providing a tab-based interface, wherein the interface includes a plurality of tabs, wherein each tab has an associated content view; and
manipulating a tab to repartition the associated content view.

2. The method of claim 1, wherein the manipulating step comprises:
merging at least two tabs.

3. The method of claim 1, further comprising:
creating a partitioned view of a plurality of associated content views.

4. The method of claim 3, further comprising:
saving the partitioned view.

5. The method of claim 2, wherein the merging step further comprises one of consuming the two tabs and leaving the two tabs intact.

6. The method of claim 1, wherein the tab-based interface comprises one selected from the group consisting of: tabbed browser and tabbed portal interfaces.

7. The method of claim 2, further comprising:
saving the at least two merged tabs.

8. The method of claim 2, wherein the merging step further comprises:
creating a partitioned view of a plurality of associated content views.

9. The method of claim 3, wherein the associated content views are horizontally sequenced or vertically sequenced.

10. A system for providing user-directed repartitioning of content of tab-based interfaces, comprising:
a system for providing a tab-based interface, wherein the interface includes a plurality of tabs, wherein each tab has an associated content view; and
a system for manipulating a tab to repartition the associated content view.

11. The system of claim 10, wherein the manipulating system comprises:
a system for merging at least two tabs.

12. The system of claim 10, further comprising:
a system for creating a partitioned view of a plurality of associated content views.

13. The system of claim 12, further comprising:
a system for saving the partitioned view.

14. The system of claim 11, wherein the merging system further comprises one of a system for consuming the two tabs and a system for leaving the two tabs intact.

15. The system of claim 10, wherein the tab-based interface comprises one selected from the group consisting of: tabbed browser and tabbed portal interfaces.

16. The system of claim 11, further comprising:
a system for saving the at least two merged tabs.

17. The system of claim 11, wherein the merging system further comprises:
a system for creating a partitioned view of a plurality of associated content views.

18. The system of claim 12, wherein the associated content views are horizontally sequenced or vertically sequence.

19. A program product stored on a recordable medium for providing user-directed repartitioning of content of tab-based interfaces, which when executed comprises:
program code for providing a tab-based interface, wherein the interface includes a plurality of tabs, wherein each tab has an associated content view; and
program code for manipulating a tab to repartition the associated content view.
